(19) United States
(12) Patent Application Publication
(10) Pub. No.: US 2005/0091127 A1
(43) Pub. Date: Apr. 28, 2005

(54) On-line virtual catalogue or flyer

(76) Inventors: Ronald L Saltel, Winnipeg Manitoba (CA); Cameron J Saltel, Winnipeg Manitoba (CA); Daniel L Saltel, Winnipeg Manitoba (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/486,709

(22) PCT Filed: Aug. 15, 2002
(86) PCT No.: PCT/CA02/01260

Related U.S. Application Data
(60) Provisional application No. 60/312,067, filed on Aug. 15, 2001.

(51) Int. Cl. G06F 17/60

(52) U.S. Cl. 705/27

(57) ABSTRACT

The present application relates to a NEW, “REVOLUTIONARY”, patent pending, “Internet” Technology—VIRTUAL “Catalogue” Shopping. The New, VIRTUAL “Catalogue” Shopping software will “Revolutionize” the way products are “Marketed” and “Presented” for sale on the Internet and the way Consumers and Businesses Shop Online.

### I. INTRODUCTION

The present application relates to a NEW, “REVOLUTIONARY”, patent pending, “Internet” Technology—VIRTUAL “Catalogue” Shopping. The New, VIRTUAL “Catalogue” Shopping software will “Revolutionize” the way products are “Marketed” and “Presented” for sale on the Internet and the way Consumers and Businesses Shop Online.

Basically, the NEW, “Revolutionary” VIRTUAL “Catalogue” Shopping system may TRULY Replicate or Duplicate the ease and convenience of consumers (or businesses) shopping for products from a beautiful, “PRINTED”, full color Catalogue or Flyer—BUT, when shopping on the Internet.

Contrarily, TODAY almost ALL, if not all, Online Retailers use the time-consuming, frustrating, Standard “Category/Sub-Category” system, which requires consumers to “pin-down” the EXACT type of product (s) which he/she may want to view (by selecting a product category and, subsequently, several additional sub-categories of products) BEFORE they see any photos, descriptions or pricing information of the many products for sale (except for a few “featured” products). This STRICT, regimented procedure severely restricts the amount of “Impulse” buying done by consumers on the Internet today, and also wastes a tremendous amount of consumers' time by their “clicking” back-and-forth to the various categories and sub-categories within any of the Online Retailers' web sites—particularly when the consumers DO NOT know EXACTLY what specific products they would like to buy (which is very, very common). The Standard “Category/Sub-Category” system simply does NOT allow consumers the opportunity or convenience of BROWSING on the Internet, like they can through a Retail Store or printed Catalogue or Flyer—to see if there are any products which they may wish to purchase—many on “Impulse”.

Alternatively, the “Revolutionary” VIRTUAL “Catalogue” Shopping system provides a great, NEW, fast and efficient shopping experience for consumers—its like “opening up” and “BROWSING” through a beautiful, “PRINTED”, full color “Catalogue” or “Flyer”. Consequently, Online customers will see “good-size” photos with descriptions and pricing information for ALL products, STARTING right at the beginning of the VIRTUAL “Catalogue”—WITHOUT the consumers having to FIRST pick a specific category and, subsequently, many, many additional sub-category listings (to select or pin down the EXACT TYPE of product which they are interested in buying) BEFORE being able to review “Specific” product photographs &/or listings, as required when shopping today at the vast majority, if not all, of Online Retailers. In essence, VIRTUAL “Catalogue” Shopping will provide consumers with a UNIQUE, Online “Catalogue” or “Flyer” format, which has been successfully used by major Retailers and Mail Order/Catalogue Houses in Canada, U.S.A. and other countries throughout the world for decades & decades (by sending beautiful, “PRINTED”, full color Catalogues and Flyers to consumers' homes).

The VIRTUAL “Catalogue” Shopping system provides ONE of the very best, NEW, great, “consumer-friendly” shopping experiences for ALL consumers on the Internet and, in particular, for those consumers who do NOT know EXACTLY what they want to buy—they simply want to BROWSE quickly through pictures of a WIDE variety of products (like Retail/Mail Order Catalogues & Flyers) to get some ideas and, in many cases, purchase on “Impulse” from the great photos and descriptive information provided.

It has been proven over decades & decades that consumers thoroughly enjoy quickly “glancing” or “BROWSING” through full color, “PRINTED” Catalogues and Flyers (with great photos of each product, descriptions and pricing/savings information). Not only do consumers look for “specific” items in same, but they also see items (Photos) which they “Impulse” Buy because of the great, eye-catching, attractive “pictorial” presentations (with accompanying product descriptions and pricing information) of these items. In addition, glancing through Catalogues and Flyers is also extremely helpful in assisting consumers in deciding on “specific” items to buy as “gifts” or for their home, office, cottage, car, themselves, etc. The NEW, Revolutionary VIRTUAL “Catalogue” Shopping system captures ALL of these market-proven advantages of the beautiful, “printed”, full color Catalogues and Flyers.

Basically, there is a tremendous NEED for the “Revolutionary” VIRTUAL “Catalogue” Shopping system on the Internet today. Consumers, businesses and Online Retailers will be saying—“AT LAST !!—A system on the Internet which may TRULY replicate Catalogue and Retail Store shopping”.

Following are just a few of the MAIN reasons why the VIRTUAL “Catalogue” Shopping system will be a welcomed addition to the Internet, not only by Consumers, but also by E-tailers, Search Engine Companies, Internet Service Providers and Computer Software & Systems Companies:

Since the present VIRTUAL “Catalogue” Shopping Technology very specifically FILLS the above mentioned “VOID”, among other things, (it REALLY does DUPLICATE “Catalogue” Shopping), our VIRTUAL “Catalogue” Shopping Technology may also become a very major component in the next generation of e-commerce sites (both Business-to-Consumer & Business-to-Business). The potential number of customers for VIRTUAL “Catalogue” Shopping is absolutely enormous—Tens (if not hundreds) of thousands of E-tailers (both B-to-C and B-to-B), as well as thousands of Search Engine Companies, Internet Service Providers, Computer Software & Systems Companies, etc. worldwide.

In addition, the present “Revolutionary” VIRTUAL “Catalogue” Shopping Technology is totally adaptable to providing the very best possible “pictorial” presentation of products, in a very consumer-friendly manner, on the smaller (compared to PC's) “hand-held” devices (& PDA's) connected to the Internet. This market is expected to grow at astronomical rates in the next 2-5 years.

Furthermore, the exceptional “pictorial” presentation of products (with product descriptions and pricing information) in the VIRTUAL “Catalogue” Shopping system will also create a fantastic, eye-catching, easy-to-use, consumer-friendly shopping system for consumers using their own TELEVISIONS, for example, for Internet shopping. Just imagine how appealing any of the VIRTUAL “Catalogue” Shopping web pages would appear on small or large television screens—as consumers just easily & casually “flip” through the Catalogue pages on their TELEVISION screens, WITHOUT having to endure the cumbersome, time-consuming frustrating steps required in the Standard “Category/Sub-Category” systems used Online TODAY.

Considering the enormous anticipated growth rates in the near future of consumers using their televisions for the Internet, the potential growth for VIRTUAL “Catalogue” Shopping in this area ALONE is very, very substantial. Since these consumers, in general, would be less “computer literate” than those using PC's &/or “hand-held” devices, the simplified method of shopping with the VIRTUAL “Catalogue” Shopping system would be a tremendous advantage for them.

II. VIRTUAL “Catalogue” Shopping—SUPPLEMENT, NOT A REPLACEMENT

The new, VIRTUAL “Catalogue” Shopping System is designed to be a SUPPLEMENT, for example, to the many small, medium and large Online E-tailers currently marketing their products on the Internet—it will provide consumers with a NEW, “Revolutionary”, FAST, CONVENIENT, FUN, Easy-To-Use” system to Shop Online.

VIRTUAL “Catalogue” Shopping is NOT necessarily intended to REPLACE the Standard “Category/Sub-Category” systems currently used by thousands & thousands of E-tailers (Business-to-Consumer & Business-to-Business) for selling their products Online, although it may alternatively operate alone. Our UNIQUE, VIRTUAL “Catalogue” Shopping system ties-in with any of these E-tailers' “Back-End” systems—such as customer ordering, credit card processing, checking customer credit, inventory control, sales statistics, information gathering, etc. Consequently, the “Revolutionary” VIRTUAL “Catalogue” Shopping system simply provides E-tailers with an ADDITIONAL, NEW, EXCITING, system (which is exceptionally consumer-friendly) to sell some (or all—for smaller e-tailers) of their products on THEIR OWN web sites.

Ties-In—No Interruption to E-tailers' Current Online Business

The VIRTUAL “Catalogue” Shopping system allows E-tailers to, for example, simply, quickly and economically EXPAND their web site to include the new VIRTUAL “Catalogue” Shopping system on their web site, along with their current Online system. There is NO NEED, in some implementations, for E-tailers to change or alter their current Category/Sub-Category systems—therefore, the VIRTUAL “Catalogue” Shopping system may be introduced on any E-tailer's web site without causing any interruptions to their current Online business.

Selection and Number of Products

E-tailers which sell 750-1,000 or more products on their web site would probably use the VIRTUAL “Catalogue” Shopping &/or VIRTUAL “Flyer” Shopping systems to feature only some, NOT ALL, of their products, although all products may be featured.

In some implementations, periodically, these E-tailers would select specific products to be featured in their VIRTUAL “Catalogue” or VIRTUAL “Flyer”. They would select these products from a WIDE range of different types of products which they currently sell—similar to the marketing procedure used for many decades by “brick-&-mortar” retailers for their various Catalogues and Flyers to promote a very limited number of their very best &/or great value &/or specialty buy, etc. products sold in each of their various departments.

As a result, consumers would be able to quickly (by “flipping” on-line through the VIRTUAL “Catalogue” pages) view a WIDE range & variety of different types of products from a specific e-tailer, WITHOUT enduring the time-consuming, frustrating procedure of “Clicking back-&-forth” in the various Category & Sub-Category selections of the e-tailer's web site.

The number of products to be featured on a typical VIRTUAL “Catalogue” Shopping or VIRTUAL “Flyer” Shopping web page could range from 5 to 15, for example, depending on the types of products, i.e. clothing, jewelry, toys, etc. Therefore, a typical 50 to 100 page Catalogue or Flyer would include 250 to 1,500 products—more likely averaging 500 to 1,000 products. Any number of pages and products may be used.

Example of Positioning in Web Site

Depending on the number and types of products which a particular e-tailer sells on its web site, it may decide to POSITION the VIRTUAL “Catalogue” Shopping or VIRTUAL “Flyer” Shopping system either at the beginning of its web site to feature a very WIDE range of products (which will quickly & clearly show the consumers the great range of products offered through out the entire web site), &/or at the beginning of all, or some, of its main Category Selections such as Women's Clothing, Jewelry, Giftware, etc. (to feature the WIDE variety of products and price ranges available within each of its main Categories).

Use of VIRTUAL “Catalogue” Shopping & VIRTUAL “Flyer” Shopping Logos

Our VIRTUAL “Catalogue” Shopping logo can be used in conjunction with the trademarks of many E-tailers, Mail Order/Catalogue Houses and “Brick-&-Mortar” Retailers.

Alternatively, some major E-tailers may desire to use our VIRTUAL “Flyer” Shopping logo (in lieu of VIRTUAL “Catalogue” Shopping) in order to convey to their customers that same represents their Online “FLYER”—similar to their Printed “FLYERS” which they send to consumers' homes frequently to promote specific products carried in their “brick-&-mortar” stores.

III. CURRENT ONLINE CATALOGUES

Some current “Brick-&-Mortar” retail stores, which also produce printed Catalogues, place their Catalogues Online for customers to view—i.e. they simply “SCAN in” their PRINTED Catalogues in the normal, PRINTED “Portrait” format—Not the “Landscape” format which is used for computer monitors TODAY.

Since the above mentioned current Online Catalogues are typically not designed specifically to display on the Internet (as is VIRTUAL “Catalogue” Shopping), most of their pictures appear too small (compared to VIRTUAL “Catalogue” Shopping) when displayed via the Internet on computer monitors. In addition, the printed “Words” or “Copy” describing their various products, including pricing, is typically NOT READABLE—it is too small when displayed on a computer screen. Even if consumers “blew up” the copy, it is NOT READABLE due to the resolution of the “printed” copy. Some, not many, e-tailers provide Online Flyers (instead of Online Catalogues), BUT the same problems with the current Online Catalogues also apply to the Online Flyers.

Under the current systems, if consumers want to READ some COPY for a particular product (as featured in a photograph in the Catalogue), they must “Click on” that photograph which then results in a “Second Page” or “Window” being downloaded and displayed, with the relevant copy. If the consumer then quickly reviews the Copy &/or Price and determines that he/she is simply NOT interested in same, he/she then has to “leave” that Page or Window and return to the Catalogue—a colossal waste of time for the consumers, as well as being frustrating and annoying.

Therefore, with the prior method of displaying Catalogues on the Internet (by “SCANNING in” same), ONE of the most IMPORTANT features of PRINTED Catalogues & Flyers is LOST—i.e. allowing customers to view the product descriptions and pricing information of the products in the Catalogues or Flyers at the SAME TIME as they are looking at the beautiful, “good size” pictures of the products (on the SAME PAGES in the Catalogues or Flyers).

This IMPORTANT FEATURE is a PRIME ADVANTAGE of the NEW, UNIQUE, “Revolutionary” VIRTUAL “Catalogue” Shopping & VIRTUAL “Flyer” Shopping systems—which are specifically designed for the Internet, providing the required amount of space on EACH Internet Web Page for “Copy” (using a very legible size of type), which will be displayed close or adjacent, for example, to the “Photographs” of the corresponding products.

IV. ONLINE SHOPPING SYSTEMS

In this section, we have basically outlined the major features of the current Online Shopping Systems used on the Internet TODAY, as well as the unique, “Revolutionary” features offered by the new VIRTUAL “Catalogue” Shopping and VIRTUAL “Flyer” Shopping systems. We have also provided comparisons between the aforesaid systems.

A. Standard “Category/Sub-Category” Systems—Used by Online Retailers Today

Basically, almost ALL Online Retailers today utilize a Standard “Category/Sub-Category” system to direct a consumer on their web site to a “Specific” product category, BEFORE providing “photographs” &/or “product listings” of the “Specific” products within the last sub-category selected by a consumer. Therefore, in almost ALL (if not ALL) cases, a consumer must FIRST select a product category and several sub-categories BEFORE reviewing actual photographs &/or listings of “Specific” products offered for sale by the e-tailer, and the vast majority of “other” Online Retailers today.

In these cases, AFTER a consumer “finds” a particular product (usually with a very small photo) in which he/she may be interested, the consumer may “click to” a new web page with a “reasonable” size photograph (if available) of that particular product. After reviewing the larger photo and additional description, or just reading the additional description (if NO photo is available), the consumer may quickly determine that it is not what he/she “thought it would be” or is just “not interested” in it or it is “just too expensive”—meanwhile a significant amount of the consumer's time was “wasted”, and he/she returns back to the “product photographs &/or listings” to find other products—and the “time-consuming” procedure continues on and on.

Nevertheless, this system has proven to be enormously successful for some major e-tailers—there is basically no other way to present same due to their large numbers of different products.

The VIRTUAL “Catalogue” Shopping system provides a much different approach than the above, allowing customers to review great photographs and product descriptions (including prices) STARTING right at the beginning of an e-tailer's web site, for example, (&/or major category section)—WITHOUT the customer's need to FIRST select or pin down the EXACT TYPE of product which he/she may be interested in purchasing. The VIRTUAL “Catalogue” Shopping system is outlined in more detail in the following sections herein.

It is important to demonstrate the UNIQUENESS of how the VIRTUAL “Catalogue” Shopping system will function (particularly how consumers are able to review &/or find the photographs &/or descriptions of the various products for sale in a web site) compared to the vast majority of Online Retailers.

Because of the enormous numbers of different products sold by many major Online Retailers, it is virtually impossible for them to provide photos of each product, or a substantial portion of their products, STARTING right at the beginning of their web site in order for customers to “quickly” BROWSE through them (like the VIRTUAL “Catalogue” Shopping system). INSTEAD, with many e-tailers, a customer must FIRST select a product category and, immediately thereafter, several other product sub-categories in order to reach actual product listings (with or without very small pictures) of a number of products offered for sale within ONLY the last sub-category selected.

In the following Section, we have outlined the various steps which a customer must take while shopping at an exemplary in order to see ACTUAL product listings &/or photographs of the various products offered for sale on its web sites.

### EXAMPLE #1

### “Primary” Program

1. HOME Page (select “Tools & Hardware”)

2. Tools & Hardware Page (select “Tools & Equipment”)

3. Tools & Equipment Page (select “Cordless Tools”)

4. Cordless Tools Page (select “Drills & Drivers”)

5. Drills & Drivers Page—this section provides a picture, description and price for 98 different products within this sub-category (select “any product” for a larger picture, ordering information and more details of same).

6. Larger Picture on “ONE” Product Page (includes ordering information & more details)

On (2) and (3), a few pictures of the “Specials” and “Featured” products only were shown in this example. Actual product listings and small photos of several products were not shown until (5). Consequently, a customer has to select or pin down the EXACT TYPE of product (e.g. Cordless Tools>Drills & Drivers) which he/she is interested in BEFORE being able to review several products offered for sale and, then, ONLY the products in the last sub-category selected—“Drills & Drivers”.

### EXAMPLE #2

### “Primary” Program

1. Tool Holsters Page—this section is comparable to (5) above, except the pictures and descriptions on these pages are presented in a different format than (5). To arrive at this page, the consumer would have to go through “similar steps” to (1) to (4) above to select or pin down the EXACT TYPE of product, i.e. “Tool Holsters”. This section provides, in this example, a very small picture (or NO picture), description and price for 27 different products within this sub-category (select “any product” for a larger picture, ordering information, and more details of same—some products will NOT have a picture).

“Other” Types of Product Selections

Besides the REGULAR type of product selections by “CATEGORIES” only (as discussed above), several Online Retailers, ALSO offer some “Specialty” choices of selecting products, such as: Age Ranges, Brands, “The Best”, Gift Ideas, Top Sellers, Themes, Shop for Him, Shop for Her, Price, etc. Some (NOT all) of the example “Specialty” choices are utilized by various Online Retailers, depending on the types of products which they sell.

Even though the FIRST selection by a consumer on the web site of retailers may be one of the “Specialty” choices mentioned above (e.g. Age Range), the consumer would immediately, thereafter, still be required to select further sub-categories of types of products BEFORE being able to review “Specific” product photographs &/or listings of the various products for sale. This procedure will NOT be required for The VIRTUAL “Catalogue” Shopping system

B. VIRTUAL “Catalogue” Shopping System

Basically, ONE of VIRTUAL “Catalogue” Shopping system's “PRIMARY” Market Strategies (compared to the vast majority of Online Retailers) is to provide “good-size” photo's with descriptions and pricing information for ALL products, STARTING right at the beginning of a web site or major category in a web site—WITHOUT the consumers having to FIRST pick a specific category and, subsequently, many, many additional sub-category listings (to select or pin down the EXACT TYPE of product in which they are interested in buying) BEFORE being able to review “Specific” product photographs &/or listings (as required when shopping at the vast majority of Online Retailers). In essence, the VIRTUAL “Catalogue” Shopping system provides the consumers with a UNIQUE, “Revolutionary” Online “Catalogue” or “Flyer” format.

It has been apparent over the decades that consumers thoroughly enjoy quickly “glancing” or “BROWSING” through the beautiful, printed, full color Catalogues and Flyers (with great photos of each product, descriptions and pricing/savings information). Not only do consumers look for “specific” items in same, but they also see items (Photos) which they “Impulse buy” because of the great, eye-catching, attractive “pictorial” presentations of these items in the full color, printed Catalogues and Flyers. In addition, glancing through Flyers and Catalogues is also extremely helpful in assisting consumers in deciding on “specific” items to buy as “gifts” or for their home, office, cottage, car, themselves, etc. The UNIQUE VIRTUAL “Catalogue” Shopping system captures all of these market-proven advantages of the printed, full color Catalogues and Flyers. VIRTUAL “Catalogue” Shopping customers do NOT have to pre-determine the EXACT category and many sub-categories of an item which they may wish to purchase.

By VIRTUAL “Catalogue” Shopping using the Catalogue and Flyer formats to sell items online, it provides its Online E-tailers with ONE of the very BEST, UNIQUE, most “consumer-friendly”, “time-saving” shopping experiences for consumers Online today. Besides providing photos for each product, said system will also present the pictures and description/pricing information in very unique (to online), attractive, eye-catching, easy-to-use, colorful presentations—making it a “real” pleasure for consumers to Shop Online at any VIRTUAL “Catalogue” or VIRTUAL “Flyer” web site.

C. VIRTUAL “Catalogue” Shopping vs. Standard “Category/SubCategory” Systems

While shopping at many e-tailers, it is absolutely essential for consumers to have a “real good” or “exact” idea of the “specific” type(s) of products which they want to buy (i.e. consumers must FIRST pick a specific product category and, immediately thereafter, many additional sub-categories BEFORE being able to review “Specific” product listings). In fact, in an exemplary e-tailer's instructions, it points out that the “quickest way to search is to simply plug the right word (product name) into the Search box”—e.g. Puzzle. Consequently, the e-tailer's program (& the vast majority of “other” Online Retailers' programs) does NOT allow customers to simply BROWSE a WIDE range and variety of products quickly—which VIRTUAL “Catalogue” Shopping does allow. With The VIRTUAL “Catalogue” Shopping system, consumers will very quickly discover products to buy which they never initially even thought of purchasing.

Therefore, our VIRTUAL “Catalogue” Shopping system may provide a great, “consumer-friendly” shopping experience for ALL consumers and, in particular, for those consumers who do NOT know EXACTLY what they want to buy—but would like to BROWSE through pictures of a WIDE range and variety of products quickly to get some ideas and, in many of cases, purchase on “Impulse” from our great photos and descriptive information.

Other “Unique Features” and “Advantages” of our VIRTUAL “Catalogue” Shopping system, compared to the vast majority of Online Retailers, are briefly outlined below:

1. Full Color “Catalogue” or “Flyer” Format

As illustrated by our sample VIRTUAL “Catalogue” & VIRTUAL “Flyer” Shopping web site pages, when consumers shop on a VIRTUAL “Catalogue” or a VIRTUAL “Flyer”, it will be like “opening up” and “BROWSING through” a beautiful, printed, full color “Catalogue” or “Flyer” with a WIDE range and variety of products. UNLIKE currently buying from the vast majority of Online Retailers, VIRTUAL “Catalogue” Shopping does NOT require consumers to FIRST select a product category and, subsequently, several other sub-categories BEFORE providing photographs, descriptions and pricing of the many products offered for sale. The customers start seeing photographs, descriptions and pricing typically right at the very BEGINNING of a VIRTUAL “Catalogue” or VIRTUAL “Flyer” Shopping web site.

All the descriptive and pricing information for each product on the VIRTUAL “Catalogue” Shopping web site is readily available for the consumer to read on the SAME page as the photographs for same—there is NO need to “CLICK to” another page for this information. Customers can very quickly “glance” at the “good-size”, eye-catching photographs of the various products and determine whether or not they are interested in same—a quick “glance” at the descriptions and prices of the “interested” items allows consumers to very quickly determine whether or not they are interested in purchasing same &/or in reviewing the larger photos and more detailed descriptions of same—just like shopping with a beautiful, PRINTED, full color Catalogue or Flyer.

Once the “quick” decision “to buy” or “to pass” on an item is made, the consumer simply “CLICKS to” the next page for either more products in the SAME category or, if completed same, to more products in a DIFFERENT category. Unlike shopping on almost ALL Online Retailers' web sites, at this point, there is NO NEED to exit the current category of products, go back to the “Home page”, select another product category and, immediately thereafter, select several other product sub-categories in order to view NEW products. VIRTUAL “Catalogue” Shopping's system is significantly faster and, we feel, much more “consumer-friendly”.

2. “MULTIPLE” Products per Photograph

The “Regular” or “Standard” systems used by the vast majority of Online Retailers, are to present “ONE Product per Photo” (many photos without any complementary backgrounds). No doubt, this procedure is the easiest to “set-up” new products and provides significant flexibility for “sorting” a specific product to one or more “Specialty” sub-categories (e.g. Age Range). It was also the FIRST system used by programmers for Internet sales, and e-tailers simply adhered to the same system to date.

However, the “ONE Product Per Photo” system (particularly with no complementary background) also has substantial limitations regarding the effectiveness of creating great, eye-catching, attractive, good-size “pictorial” presentations of the products. The VIRTUAL “Catalogue” Shopping's “MULTIPLE Products per Photo” (with great “backgrounds”) has substantial “visual IMPACT” and allows for “much larger” pictures of the products—thereby, creating truly great, eye-catching, attractive, informative (with “good-size” photos) “pictorial” presentations of its products. As a result, the “perceived” value of each product in VIRTUAL “Catalogue” Shopping systems is also enhanced which, in turn, may generate more sales per item and, in many cases, allow for higher selling prices of same.

We have developed the efficiencies, economies and logistics to implement and maintain our UNIQUE “MULTIPLE Products per Photo” program. Another PRIME advantage of this program is that it allows us to include substantially more product photographs per computer page (compared to the “standard” procedure) and, at the same time, VIRTUAL “Catalogue” Shopping presents “larger” photos and “great descriptions & pricing” information for EACH product.

3. Easy Reference by “Page Numbers”

The “Regular” or “Standard” system of sorting by product categories and sub-categories is used by the vast majority of Online Retailers. Since consumers must initially “click to” a main product category and, subsequently, several sub-categories to virtually “find” certain products offered for sale, there is NO consistent “page numbering system” within same. ONLY within a specific final sub-category (e.g. Cordless Tools—“Drills & Drivers”) are the pages numbered.

Consequently, when consumers are “checking” many products in these programs and decide to “re-visit” a specific product for “another look” &/or “to purchase”, it is essential for them to remember in which final sub-category it appeared, how he/she got there (what other sub-categories and main categories did he/she previously visit)—and, if remembers, he/she must follow all these steps again to find that specific product. This can be a very time-consuming, frustrating experience for consumers BUT, nevertheless, is essential for these programs. The only way consumers may avoid same is if they “bookmark” each “specific” product in which they are interested, while shopping at the vast majority of Online Retailers. To “Bookmark” each “specific” product, consumers must first visit the “Single Page per Product” for EACH of their interested products which, again, is a much more time-consuming procedure compared to the VIRTUAL “Catalogue” Shopping system—just “GO to” a page number (like shopping with a printed Catalogue or Flyer).

Alternatively, another UNIQUE feature of the VIRTUAL “Catalogue” Shopping system is that it will have ALL of its web site pages numbered consecutively, like Catalogues & Flyers. Therefore, when a consumer sees a product which he/she is, or may be, interested in buying, he/she simply makes a “mental” or “written” note of its Page NUMBER, or “CLICKS to” the “My Favorites” icon (which will automatically store all the customer's “Favorite Pages”) at the top of each page—creating the Customer's OWN Personalized “CATALOGUE” or “FLYER” of all products which he/she is interested in buying. The customer then continues to BROWSE through the VIRTUAL “Catalogue” or VIRTUAL “Flyer”. When the customer decides to “re-visit” a “specific” product or “all” products which he/she was “interested” in buying on our web site, he/she simply “CLICKS to” the appropriate Page NUMBER to view that “specific” product again or visits his/her “Favorite Pages” by “Clicking on” the “My Favorites” button at the top of each web page.

With VIRTUAL “Catalogue” Shopping, there is NO NEED for the time-consuming, frustrating experience referred to above (re: the vast majority of Online Retailers' “Standard” procedure). VIRTUAL “Catalogue” Shopping's web sites offer the same convenience afforded to a customer of simply “flicking back” to a certain page in a beautiful, printed color Catalogue or Flyer to find a “specific” product which he/she originally saw and was interested in purchasing.

4. “Category” & “Specialty” Product Selections

Besides the UNIQUE feature of consumers being able to quickly BROWSE through various “pages” of a VIRTUAL “Catalogue” Shopping web site to see a WIDE range and variety of products, several other, important, UNIQUE “features” are also available in same.

Every VIRTUAL “Catalogue” Shopping web site may include an “INDEX” (a listing of the various types &/or categories of products offered for sale and their corresponding Page NUMBERS within the web site). If a customer wants to visit directly to a specific “product type” or “category” (e.g. Baby Products), he/she simply “CLICKS to” the first corresponding Page NUMBER for same and, subsequently, BROWSES through the pages illustrating ALL Baby Products. With VIRTUAL “Catalogue” Shopping, there is NO NEED to “click to” further sub-categories, as with other Online Retailers.

Similarly, if a customer wants to BROWSE through a VIRTUAL “Catalogue”, BUT he/she is not interested in certain categories or types of products, he/she simply “skips over” their corresponding web pages.

In addition, VIRTUAL “Catalogue” Shopping may also include certain “Specialty” Product Selection methods in which customers can pin down the SPECIFIC PAGES of specific products in which they are most interested (e.g. Gifts for Him, Gifts for Her, Themes, Father's Day, Mother's Day, Age Ranges, etc.).

V. ADVANTAGES of VIRTUAL “Catalogue” & VIRTUAL “Flyer” Shopping Systems

Following is a brief summary of the many advantages of the VIRTUAL “Catalogue” Shopping & VIRTUAL “Flyer” Shopping systems for both Consumers and Online Retailers, compared to the Standard “Category/Sub-Category” shopping systems currently used by almost ALL Online Retailers TODAY.

A. Consumers (& Purchasers in B-to-B Web Sites)

1. Gives consumers a WIDE selection of an e-tailer's product line very quickly—its like BROWSING through a beautiful, PRINTED, full color Catalogue or Flyer—INSTEAD of the time-consuming, frustrating experiences (in the Standard “Category/Sub-Category” systems) of consumers “clicking” back & forth on the various product categories & sub-categories to attempt to simply find the type(s) of products which they may be interested in purchasing.

2. Fast, Convenient, Fun & Easy-to-Use—Just 1 or 2 Clicks, for example, (1 click to each Catalogue Page and 2^{nd} click, if desired, to 2^{nd} Page for larger photograph of product, more detailed description and ordering information) to view and order products—NOT typically 4 to 6 different clicks to various Categories and Sub-Categories before even viewing various products for sale—as per the Standard “Category/Sub-Category” systems used Online TODAY.

3. Provides great “Pictorial” presentations and, UNLIKE the Standard “Category/Sub-Category” systems, includes sufficient detailed descriptions of each item so the Consumers can decide whether or not they are interested in purchasing specific products. NO NEED—to “GO To” Page 2 for “further information” (as per Standard systems) when just trying to decide “initially” whether to consider &/or to buy specific products.

B. Online Retailers

1. Pre-determined “Templates” & “Grids” systems allow e-tailers to utilize (in the preparation of their VIRTUAL “Catalogue” &/or VIRTUAL “Flyer” web pages) their EXISTING artwork, photographs and copy from their current PRINTED colored Catalogues &/or Flyers. NO NEED for special “ONE Product Per Photo” photographs—as required for the Standard “Category/Sub-Category” systems. The “Templates” & “Grids” systems allow e-tailers to very quickly, efficiently and economically prepare their VIRTUAL “Catalogue” &/or VIRTUAL “Flyer” web pages “initially” and “periodically”, as desired. There is NO NEED, in some implementations, for each e-tailer to spend very substantial amounts of money and time “designing” & “developing” new “Catalogue” &/or “Flyer” pages each time that they wish to change their product content.

Our Pre-Packaged SOFTWARE program allows ANY e-tailer to simply ADD our VIRTUAL “Catalogue” Shopping &/or VIRTUAL “Flyer” Shopping System to their EXISTING shopping web site—typically at very minimal COST and EFFORT. Our systems can be a SUPPLEMENT TO EXISTING shopping web sites—NOT A REPLACEMENT (unless e-tailers request same).

2. Will likely substantially increase “IMPULSE” sales (from consumers) which e-tailers may never otherwise have ever secured from their Standard “Category/Sub-Category” web site—because it is easy for consumers to “BROWSE” through the VIRTUAL “Catalogue” &/or VIRTUAL “Flyer” and “SEE” items which they consequently decide to buy on “Impulse”.

3. The addition of a VIRTUAL “Catalogue” &/or VIRTUAL “Flyer” program may provide e-tailers with an additional source of revenue (besides their regular web site sales) from the additional sales of their “featured” products. The “easier-to-use”, convenient, fast, “consumer-friendly” VIRTUAL “Catalogue” &/or VIRTUAL “Flyer” programs will also attract consumers to the e-tailer's web sites and encourage repeat visits by consumers to them.

4. Allows more products to be displayed in a SINGLE photograph compared to the current “ONE Product Per Photo” system (used in the Standard “Category/Sub-Category” systems), resulting in less space per product (for downloading) BUT, at the same time, provides e-tailers with substantially better eye-catching, “Pictorial Presentations” of its products. Same results in greater perceived value for its products and, no doubt, will likely substantially increase sales for the products displayed in the VIRTUAL “Catalogue” &/or VIRTUAL “Flyer” (compared to the current “ONE Product Per Photo” system).

5. Pre-determined “Templates” & “Grids” systems also provide space for e-tailers to present and utilize the many advertising features successfully used in their PRINTED colored “Flyers” (&/or Catalogues), such as: Sale, % off, 2 for 1 Price, etc. As apparent in traditional retailing, these “features” can be very successful in promoting retail sales.

6. Keeps consumers in an e-tailers' web site much longer (because it's so Simple, Fast, Convenient, Fun & Easy-to-Use for the consumer) and allows consumers to see a very wide range of different products offered by an e-tailer—rather than a consumer just searching a few categories/sub categories and then leaving the web site (as often occurs in the vast majority of cases).

VI. TIMING

The “TIMING” to introduce VIRTUAL “Catalogue” Shopping NOW—is GREAT! This “Revolutionary” Shopping System brings many, many advantages to ALL segments of the Internet market, i.e. Consumers, E-tailers, Internet Portals, Search Engine Companies, Internet Service Providers and Computer Software & Systems Companies.

Following are just a few of the more significant reasons why “NOW” is the perfect time to introduce VIRTUAL “Catalogue” Shopping:

A. Consumers

1. Improve Online Shopping System

A great many consumers have found the Standard “Category/Sub-Category” systems, which are used by almost ALL Online Retailers today, to be very frustrating and very time-consuming—wasting a lot of their treasured “free” time. What is needed NOW, is a much, for example, simpler, easier-to-use, faster, more convenient and more “consumer-friendly” Online Shopping System—the NEW, “Revolutionary” VIRTUAL “Catalogue” Shopping &/or VIRTUAL “Flyer” Shopping systems may provide ALL of these highly desired benefits for Online Shoppers.

2. Increase Sales of E-tailers' “Selected” Products

It is apparent in the “brick-&-mortar” retail industry that sales of products which are “advertised” in PRINTED Flyers &/or Catalogues far exceeds sales of products which are not advertised, and are sold strictly off the retailers' shelves.

As discussed earlier herein, e-tailers would typically “select” various products to “advertise” and “promote” by placing them in their VIRTUAL “Catalogue” &/or VIRTUAL “Flyer” programs at the beginning of their web sites &/or at the beginning of all or some of their main category sections. As per the traditional retail business, the sales of these “advertised” and “promoted” products in the VIRTUAL “Catalogue” &/or VIRTUAL “Flyer” programs should be substantially more than the sales of the SAME or similar products sold only in their normal Standard “Category/Sub-Category” systems. Unless consumers “click on” the main Category &/or Sub-Categories to “pinpoint” specific products to view, the consumers may never even know that those “unadvertised” products were even offered for sale (similar to consumers just simply “not seeing” specific products in a “brick-&-mortar” retail store). In addition, the high impact, eye-catching, informative “pages” of a VIRTUAL “Catalogue” or VIRTUAL “Flyer” may also stimulate substantial “Impulse” sales of items which consumers were not initially looking for, but found the product presentations and offerings too good to pass up.

Both consumers and traditional retailers have USED the Catalogue & Flyer formats (PRINTED) successfully for shopping and selling products, respectively, for decades and decades.

Therefore, the NATURAL, NEXT STEP OR NEXT GENERATION of Online Shopping should utilize the “Catalogue” & “Flyer” formats, but adapted from the “Printed” format to the “Internet Online Shopping” format and including many other features—as offered by the NEW, “Revolutionary”, VIRTUAL “Catalogue” Shopping & VIRTUAL “Flyer” Shopping Systems.

3. New Internet Appliances

With the advent of more and more simplified and less costly (compared to a regular PC system) Internet appliances, including Web TV and other similar systems, many consumers using these systems are typically less “computer-literate” than those using PC's and “hand-held” devices. Consequently, our VIRTUAL “Catalogue” Shopping system allows many of these consumers to Shop Online in the manner in which they expect—a simplified, easy-to-use, convenient, fast, “consumer-friendly” Online Shopping System that, for example, does NOT waste their time and is NOT complicated. The consumers simply “flip” through the Catalogue or Flyer pages on their TELEVISION (or other Internet appliance) screens—WITHOUT enduring the cumbersome, time-wasting steps required with the typical Standard “Category/Sub-Category” systems used Online TODAY.

4. Hand-Held Devices

With the increasing popularity, and the expected astronomical growth rates, of the various “hand-held” devices (PDA's) connected to the Internet, the simplified, easy-to-use, convenient, fast, “consumer-friendly” VIRTUAL “Catalogue” Shopping system will likely be in strong demand. Consumers using these “hand-held” devices to connect to the Internet for Online Shopping (probably away from their home or office—otherwise they would probably use their PC's) would be in “a hurry” for the product photographs and description/pricing information. Rather than waste a lot of time clicking “back-&-forth” between Categories and Sub-Categories—at least 4-6 times, for example, for EACH category (with current “Standard” online systems) to try find product(s) which they are interested in, with our VIRTUAL “Catalogue” Shopping system they would easily and quickly simply “flip” through the “Catalogue” or “Flyer” pages to view various products (including all descriptions/pricing information). Furthermore, the smaller screens of PDA's would also make it difficult and frustrating to click “back-&-forth” on the current Standard systems to attempt to ultimately find products which the consumers may be interested in buying—as compared to the simple procedure of “flipping” through beautiful, color “Catalogue-like” pages with the VIRTUAL “Catalogue” Shopping system.

B. Online Retailers

1. Looking for New & Better Ways to Sell Products Online

Over the past few years, Online Retailers have been consistently attempting to make it as “easy as possible” for consumers to Shop Online.

The VIRTUAL “Catalogue” Shopping system may truly provide a NEW, “Revolutionary”, Online Shopping system which may provide small, medium and large size e-tailers with advantages in improving the ease, simplicity, convenience, fun and efficiency for consumers to shop on their web site. In addition, the VIRTUAL “Catalogue” Shopping system may substantially improve the amount of “Impulse” sales which e-tailers should achieve (compared to the current online shopping systems).

2. Increase Sales of Online Retailers

Consumers are often frustrated with the current Online Shopping Systems:

(a) Under the current Standard shopping systems, unless consumers “bookmarked” an item that they thought may interest them, it is a time-consuming and frustrating experience “trying to go back and find” the item(s) before making the final purchasing decision—they have to remember the various Sub-Categories that they “clicked on” and then, if they do remember, they have to re-do same. If they want to re-look at several products, the task becomes even more cumbersome and time-consuming.

Having to “bookmark” EACH item of interest and “retrieve” same via the “bookmark” system is time-consuming and frustrating for consumers—particularly if several items are involved (which could be considered the NORM).

With VIRTUAL “Catalogue” Shopping or VIRTUAL “Flyer” Shopping, the customer simply “clicks” to a certain page number (which can even be earmarked quickly as “My Favorites” within a web site) or to several page numbers (if several products), and then quickly “flips” back-and-forth—like “flipping” through a beautiful, PRINTED, full color “Catalogue” or “Flyer”.

(b) In addition, a “Personalized” Catalogue or Flyer is created while a customer is reviewing a VIRTUAL “Catalogue” or VIRTUAL “Flyer”—by he/she simply ADDING each page of interest to their “My Favorites”. At any time, for example, a customer can quickly review, in order, ONLY the pages which he/she ADDED to “My Favorites”—just like, in fact better than, a customer marking pages of interest in a printed Catalogue or Flyer by creasing the page corners, using Post-it notes etc.

Under the current Standard “Category/Sub-Category” shopping systems, if a consumer finds one item in a current web site that he/she would like to buy, and then continues on to “look at” other products that he/she may be interested in purchasing, he/she could become so frustrated and feel the waste of their precious “free” time that he/she simply “abandons” the web site out of pure frustration WITHOUT going back to purchase an initial item, (or several items) which he/she intended to buy.

The Simplicity, Speed and Ease of shopping in the VIRTUAL “Catalogue” Shopping or VIRTUAL “Flyer” Shopping systems may substantially mitigate and, probably, eliminate this “consumer frustration”.

3. Consumers' Awareness of Product Selection & “Impulse” Sales

Many of the larger Online Retailers have found that a substantial number of consumers do NOT realize the wide range of different types of products which are offered on their web sites. Unless consumers “Click on” the various major Categories and follow through by “Clicking on” the typically 4 or 6 subsequent Sub-Categories of several major Categories of products on an e-tailer's web site, they would simply NOT see the “pictures” of the wide assortment of products offered for sale in same.

4. Keeping Consumers in a Web Site & “Impulse” Sales

The primary reason for consumers to leave a particular web site after, or before, purchasing an item is the requirement (under the “Standard” systems) for the constant “Clicking on” various Categories and Sub-Categories (typically 4-6 times EACH Category) BEFORE viewing pictures of specific types of products for sale. The Ease, Convenience, Speed, Fun and “Entertainment” of simply “flipping” through the Catalogue or Flyer pages of the VIRTUAL “Catalogue” or VIRTUAL “Flyer” system, to view a WIDE range of different types of products, may keep consumers in a specific web site for a much longer period of time—AND, in many instances, result in “Impulse” sales which, otherwise, would never have been achieved by the e-tailers.

C. Internet Portals, Search Engine Companies, Internet Service Providers and Computer Software & Systems Companies

Increase Revenue Streams

The VIRTUAL “Catalogue” Shopping & VIRTUAL “Flyer” Shopping systems offer Internet Portal, Search Engine, and Internet Service Provider companies and other companies very NEW & UNIQUE ways to increase their revenue streams from the thousands and thousands of the more successful, Online Retailers today—including the major Online Retailers. Since the aforementioned Companies will be able to generate NEW types of revenues (with VIRTUAL “Catalogue” Shopping & VIRTUAL “Flyer” Shopping) from the financially stronger, more solid Online Retailers, the TIMING of introducing our NEW, “Revolutionary” VIRTUAL “Catalogue” Shopping & VIRTUAL “Flyer” Shopping systems NOW may be a welcomed additional source of revenue for the Internet Portal, Search Engine and Internet Service Provider companies today.

The Computer Software & Systems companies would also welcome the introduction of the VIRTUAL “Catalogue” Shopping & VIRTUAL “Flyer” Shopping systems TODAY. Since our new Shopping Systems can virtually be used by ANY Online Retailer (large or small, B-to-C or B-to-B), same represents potentially substantial, NEW sources of revenue for the Computer Software & Systems companies to introduce and implement our VIRTUAL “Catalogue” Shopping & VIRTUAL “Flyer” Shopping systems to their new and existing customers.

VII. INVENTIONS

The following provides a summary of various inventions, at least some of which are also discussed above. The following summary identifies exemplary inventions and is not intended to be a complete list of all inventions disclosed in the present application. Other inventions may also exist as described in the present application including the exemplary claims.

A. INDEX

System Displayed

Press “Index Page”—“Index” appears in Window, alphabetically listed by Product Categories.

“Index”, among other things, replicates an Index in a PRINTED Catalogue, usually categorized by Product Categories. Provides customers with a quick “overview” of the types of products offered for sale, the number of “pages” for each category and the specific page numbers for each category. Allows customers to quickly “GO TO” the first page of a specific category.

Index pages in PRINTED Catalogues are usually positioned in the latter half &/or near the end of the catalogues to encourage consumers to “BROWSE” or “flip through” the catalogues (thereby, stimulating IMPULSE shopping)—not just go to the Index pages, locate a category and go straight there. Therefore, like printed Catalogues and unlike almost all current web sites, we did NOT position the Index (or Category Listings) at the FRONT of the VIRTUAL “Catalogue” Shopping sections, for some implementations—we made it available “throughout” the VIRTUAL Catalogue—by pressing the Index button.

Exemplary Alternatives:

Press “Index Page”—“Index” could appear in left margin.

“Index” could permanently appear in left margin.

“Index” could be alphabetically listed by “Special” categories such as Gifts for Her, Gifts for Him, Gifts under $50, Valentine Gifts, etc. It could also be subdivided within each Category, e.g. Clothes, Women: Sweaters, Dresses, Tunics, Jackets.

“Search”, by Product Type—will outline Page Number(s) for specific product types. Will “GO TO” the 1^{st} page of the Category of Product requested.

B. INSTRUCTIONS

System Displayed—MAIN Instructions

“Click on any Photo or Copy for more info”

“QUICK Buy”—click on any purchase icon or symbol to ADD TO CART (can delete it later); an example of a “QUICK Buy” icon is shown in the appendices.

Symbol is UNIQUE to denote “QUICK Buy”

Our positioning of “symbols” in PHOTOS is UNIQUE

Our positioning of “symbols” in COPY (e.g. beside the “Catalogue-like” listing of Product Descriptions and Prices) is also UNIQUE.

Exemplary Alternatives

Other symbols could be used to denote “QUICK Buy”, such as: +SC, +Buy, +Cart, SC, Buy, Cart, QUICK Buy, and a plus (+) sign in conjunction with a design of a shopping cart.

Instructions above for purchasing may be printed on the top right corner of every Catalogue & Flyer Page.

C. LISTING OF PAGE NUMBERS

System Displayed

Allows customers to quickly review where they are in the Catalogue or Flyer &/or “jump to” another category of interest.

If a customer remembers (or makes a written note of) certain “Pages” of Interest—“listing” allows customers to quickly “jump to” specific “Pages”.

D. MY FAVORITES

System Displayed (Click on “My Favorites” Button).

Basically, “My Favorites” replicates a consumer's action of “keeping track of” (by bending page corners, marking pages with post-it notes or other markers, writing down page numbers, etc.) certain PAGES in a PRINTED Catalogue or Flyer which he/she is interested in (i.e. possibly buying products displayed on same).

Our exclusive, UNIQUE system provides a very easy-to-use, convenient, automated system of not only “keeping track of” certain PAGES, but also of “viewing them” in a very convenient, efficient and concise manner—i.e. “View My Favorite Pages ONLY”. In essence, this system produces a “Personalized” Catalogue or Flyer within a Web Site for EACH customer.

This system MAY be session sensitive—i.e. only kept for the time customer remains in a Web Site (therefore does NOT require customer to give his/her name, account number, etc.). The system may “store same” under customer's name for several days, weeks, etc. depending on E-tailers's programs regarding frequency of changing contents of Web pages in their Catalogues &/or Flyers. ALSO, My Favorites Pages could be added to a Wish List.

Exemplary Alternatives:

Could have ONE “My Favorites” or “ADD to My Favorites” button to “click on” to add page to a customer's My Favorites Pages AND a SECOND “My Favorites Pages” button to provide the list of same for additions, deletions and viewing.

When a customer clicks on “NEXT PAGE” button AND he/she is viewing the LAST page in My Favorite Pages section (windows):
An END of My Favorite Pages message could pop up:
joined to the “HAND”, &/or
on the Web Page, over photo's &/or copy, &/or
on the Top Border near 4 of 4

An additional message could also be used, such as: “Click on HOME button for General Catalogue” or “Close Window”.

A “CLOSE WINDOW” message &/or button may also be used.

Instead of separate WINDOWS, My Favorite Pages could be displayed as regular pages.

A “Back to Catalogue” icon may be displayed in top section of each WINDOW.

E. ADD TO SHOPPING CART & “PAGE 2”

System Displayed

REGULAR System

“Click on any Photo or Copy for more info”—PAGE 2 will subsequently appear for the specific product (or group of products if in same photo). Page 2 may include:

Larger photo of product(s)

More detailed description of product(s), including pricing, colors, sizes, shipping information, other options, etc.

System and instructions for customers TO ORDER (Add to Shopping Cart).

Show a larger photo of a group of products on Page 2.—Show a larger photo of a specific section of a photo of a group of products.

The MAIN pages of our “Catalogue” or “Flyer” will be able to be LINKED TO the PAGE 2's of a web site of a COMPANY which is utilizing our VIRTUAL “Catalogue” Shopping or VIRTUAL “Flyer” Shopping system. The Page 2's, of course, would be tied-into ALL the “BACK END” online systems of any particular company's web site.

Therefore, our VIRTUAL “Catalogue” Shopping or VIRTUAL “Flyer” Shopping system can be adapted by any online company, for example, efficiently and cost-effectively since it need NOT interfere with a company's existing online shopping system, does NOT require a company to program new “BACK END” systems and allows the company to simply implement our new VIRTUAL “Catalogue” Shopping or VIRTUAL “Flyer” Shopping system as a Supplement, for example, NOT a Replacement, to its existing online marketing program.

F. “QUICK Buy”

System Displayed

TO ORDER System

This system allows a customer “TO ORDER” (ADD to SHOPPING CART) specific items directly from the VIRTUAL “Catalogue” or VIRTUAL “Flyer” Web Pages, WITHOUT the need of GOING TO “Page 2”.

The “QUICK Buy” symbol may be on the photos &/or in the copy (e.g. beside the prices), and could be used only for products, for example, not requiring further selections by customers, such as: size, color, etc. The symbols may be positioned in the copy ONLY for items which are grouped together in a single photo, for example, particularly if there is NOT sufficient space in the photo to display the symbols adjacent to each type of product and/or the placing of the symbols in the photo “clutters up” and/or “diminishes” the quality and/or effectiveness of the photo presentation of the products.

As soon as a customer “Clicks on” the symbol, the corresponding product is ADDED TO SHOPPING CART, WITHOUT the need of viewing “Page 2”.

LINKING of the “QUICK Buy” symbol to ANY Page 2 and/or directly to the “shopping cart” section of an e-tailer's web site permits easy integration of the virtual on-line catalogue with existing sites.

Since the design of our VIRTUAL “Catalogue” Shopping or VIRTUAL “Flyer” Shopping systems allow sufficient space for great-sized photographs of products AND the required product descriptions & pricing info for consumers to make a buying decision, our “QUICK Buy” system permits the consumer to make buying decisions DIRECTLY from our “Catalogue” &/or “Flyer” pages. Same provides a much simpler, easier-to-use, quicker system for consumers—compared to the Standard Category/Sub Category systems and the requirement for consumers to view Page 2 for Ordering Information.

The new “QUICK Buy” system may generate a substantial number of benefits for consumers shopping Online. The new “Quick Buy” system may ALSO provide great benefits for e-tailers since same may generate a substantial amount of “Impulse” Buying and significantly reduce the currently large percentage of Online Shoppers leaving a Web Site before finalizing a purchase.

Tie-In to E-Tailers' Web Sites

The “Add to Shopping Cart” symbol will be linked directly to an E-tailer's “BACK END” systems (similar to PAGE 2, described before) and, in particular, to its Shopping Cart/Order Processing systems. The Virtual Catalogue system has the ability to “link to” or “tie-into” one or more E-tailer's “BACK END” and Shopping Cart/Order Processing systems.

Exemplary Alternatives

Instead of “QUICK Buy” symbols placed in a single photo of a product or in a group photo of several products and/or in the copy of one or more products, a General symbol for the WHOLE Catalogue or Flyer PAGE could be used.

Instructions on the Top of each page would be: Click on symbol, THEN click on photo or copy to ADD TO CART (can delete it later).

Instead of symbol, could be:
CLICK HERE, THEN click on photo or copy
to ADD TO CART (can delete it later).
Click on QUICK Buy, THEN click on photo or copy
to ADD TO CART (can delete it later).
   Warning:

“Warning” could be adjacent to symbol.

If “Warning” is in a FIXED position on page, symbol which was “clicked on” would be highlighted or flash, etc. to denote which ITEM was ADDED TO CART.

The “Warning” can be implemented using a window, as illustrated in the Appendices, that contains, for example, an “ok” section for selection by the user to add the corresponding item to a shopping cart and a “delete” section for selection by the user to delete the corresponding item from the shopping cart. The warning window can be configured such that the user must select the “ok” section or the “delete” section to remove the warning window from the displayed page.

Also, the VIRTUAL Catalogue or Flyer can be configured such that if the user clicks on any button (for example, next page, my favorites, or home) without clicking on the “ok” or “delete” sections of the warning window, the system either halts operation until the user clicks on the “ok” section or the “delete” section or, alternatively, continues operation.

As an alternative to the use of a window, the warning can be implemented with other types of displayed information such as an icon or graphic, with audio information such as a warning chime or bell, or through other visual indicators such as flashing or changing colors of the selected “QUICK Buy” icon.

G. END of CATALOGUE or FLYER

System Displayed

When a customer is on the LAST page of a VIRTUAL “Catalogue” or VIRTUAL “Flyer” and clicks on the NEXT PAGE button, the system will automatically go back and display the FIRST page of the Catalogue or Flyer in some implementations.

Exemplary Alternatives

Since the VIRTUAL “Catalogue” or VIRTUAL “Plyer” will typically be PART OF an E-tailer's Web Site, the system can be programmed to allow (at the END of the VIRTUAL “Catalogue” or VIRTUAL “Flyer”) other alternatives (vs. above) such as:

Go back and display e-tailer Home Page—encouraging consumers to NOW browse through e-tailer's Regular Web Site.

Go back to ANY section of e-tailer's web site which it may desire.

H. “HOME” BUTTON

The “HOME” Button may be programmed to “pop up” the E-tailer's HOME Page &/or the HOME Page of the VIRTUAL “Catalogue” or VIRTUAL “Flyer” within an E-tailer's web site.

I. ADJUSTABLE “WEIGHT” of WEB Pages

a. Introduction

In the general “language” of Web Design, “WEIGHT” is shorthand for how BIG a Web page is—in KILOBYTES. A “heavy” Web page will take a long time to download, particularly if consumers are using slow modems, rather than “fast” broadband connections (many Internet users are still dialing in at 56 KB per second or slower). “Light weight” pages appear quickly, regardless of the speed of a consumer's Internet connection. As an alternative to Kilobytes, other measures of the storage space required for a web page may be used.

Recommended “Weight” of Web pages varies from 40 KB-50 KB-70 KB. However, many high traffic Web sites still use a high “average” weight of their Web pages—e.g. 91 KB. In some industries, the “average” weight of Web pages is much higher—e.g. 150 KB. Until more Internet users have “cable modems” or DSL connections, Web page “WEIGHT” is important.

At 40 KB to 50 KB “Weight”, it will take approximately 8 to 10 seconds for the Web page to appear over a 56-kbps modem connection—about the limit of most consumers' patience. Any slower, and the e-tailer (or Web page owner) risks losing customers as they give up in disgust and click away to another site before the e-tailer's Web page has even finished downloading. The increasing number of people browsing the Web using very low-bandwidth wireless connections also contributes to the need of “small” and “light weight” Web pages—if these consumers are part of a company's or e-tailer's target market.

b. What Determines “WEIGHT” of a Web Page?

The culprit, in most cases, is “graphics”. However, a Web page's “WEIGHT” includes all the graphics, buttons, HTML code, Java Script code and basic page text. Therefore, a relatively “graphics-free” Web page can still “weigh a lot” if it has a lot of code hidden behind the scenes.

c. How to Reduce “WEIGHT” of a Web Page

E-tailers (and other Web page providers) must set their “WEIGHT” limit for their Web pages by comparing same to their direct competition and the Internet in general, as well as their “estimates” of the “connection speeds” used by their target consumers—both geographically and by type of consumer.

The “WEIGHT” of Web pages can then be reduced by shrinking graphics and/or eliminating extraneous code and/or by other means.

d. VIRTUAL “Catalogue” Shopping and VIRTUAL “Flyer” Shopping

A primary difference between our VIRTUAL “Catalogue” Shopping and VIRTUAL “Flyer” Shopping Systems and the “Standard” Category/Sub-Category Systems is that, in one particular implementation, our Web pages are “STATIC”—i.e., each PAGE maintains its same presentation among, for example, multiple users or multiple viewings by the same user. As an alternative to STATIC pages, the VIRTUAL Catalogue or Flyer can have DYNAMIC pages—i.e., each PAGE has one or more features that change in any way based upon, for example, different users, different viewings by the same user, or particular interactive features. For example, a dynamic page can have one or more of the following features that makes it dynamic: a rotating banner ad that changes while a user views the page; photos that change based upon viewers, for example every fifth viewer is represented with a different photo; or a on-line video triggered by user input. As a further alternative, the VIRTUAL Catalogue or Flyer can have pages that each have both dynamic features and static features.

Each page, whether static, dynamic, or a combination, can be transmitted as a single unit or as multiple components to be assembled. Whether the page constitutes a single unit or multiple components may depend upon, for example, a weight of the page, or content such as text, graphics, or photos in the page. For example, the page may have multiple photos obtained from multiple stored JPEG files. Each page, regardless of the content, can be assembled from content stored in one or more locations, meaning one or more portions of a single database, one or more portions of multiple databases, and stored locations in one or more geographic locations. Alternatively, the whole page can be stored as, for example, one JPEG file.

As a result of “STATIC” Web pages, when used for one particular implementation, the VIRTUAL “Catalogue” Shopping and VIRTUAL “Flyer” Shopping System Web pages will have substantially less “hidden codes”, thereby decreasing the overall “Weight” of its Web pages—even though same includes substantial “graphics”—photos and copy.

In addition, because of the “STATIC” Web pages, when used for one particular implementation, EACH Web page in the VIRTUAL “Catalogue” Shopping and VIRTUAL “Flyer” Shopping Systems is easily ADJUSTABLE in SIZE—i.e., they can be reduced in size to the required “WEIGHT” LIMIT of each e-tailer's desire, in accordance with the connection speed requirements of their target markets (examples of different size Web pages are included in the Appendices). Alternatively, DYNAMIC Web pages can also be adjusted in size to varying WEIGHTS.

The VIRTUAL “Catalogue” Shopping and VIRTUAL “Flyer” Shopping Systems allow e-tailer's (and other users) sufficient space to provide “legible size” copy for product/service descriptions, pricing information, or other data to be positioned on the SAME page as the corresponding photos of same. If an e-tailer uses the recommended 10-11-12 pt. size copy, the overall Web page could be reduced substantially to decrease the “Weight” of same—and, yet, the “copy” would still be very legible on the conventional 13″ to 19″ computer monitors.

However, if an e-tailer wants to “SHRINK” its VIRTUAL “Catalogue” Shopping and VIRTUAL “Flyer” Shopping Systems Web pages so much that the regular 10-11-12 pt. copy will NOT be easily legible, the VIRTUAL “Catalogue” Shopping and VIRTUAL “Flyer” Shopping Systems provide the necessary space (for example, templates or grids) in which the e-tailer may insert the “proper size” copy which WILL be legible in the final size of Web pages which it selected.

Therefore, a PRIMARY advantage of VIRTUAL “Catalogue” Shopping and VIRTUAL “Flyer” Shopping Systems of having easily “legible” copy on the SAME Web page as the corresponding photos for same WILL BE MAINTAINED, regardless of the FINAL SIZE of the VIRTUAL “Catalogue” Shopping and VIRTUAL “Flyer” Shopping Web pages which an e-tailer may use.

Furthermore, because relatively “LARGE” size photos of products are placed in the UNIQUELY designed VIRTUAL “Catalogue” Shopping and VIRTUAL “Flyer” Shopping Systems Web pages (as compared to SMALL size photos used by most e-tailers today), the VIRTUAL “Catalogue” Shopping and VIRTUAL “Flyer” Shopping Systems Web pages can be reduced very substantially to accommodate an e-tailer's WEB page “WEIGHT” limit—and, yet, the photos of same will be very legible, depicting very true, detailed, attractive, eye-catching, colorful presentations of the products offered for sale.

As the speed of Internet connection increases in an e-tailer's target market areas, it may also increase the SIZE of its VIRTUAL “Catalogue” Shopping and VIRTUAL “Flyer” Shopping Systems Web pages accordingly to provide an even better presentation of its products to its customers. The UNIQUE design of the “STATIC” VIRTUAL “Catalogue” Shopping and VIRTUAL “Flyer” Shopping Systems Web pages, with their relatively “large” photos and very legible size of copy, will allow e-tailers to quickly and economically ADJUST the size of their VIRTUAL “Catalogue” Shopping and VIRTUAL “Flyer” Shopping Systems Web pages, as desired, or alternatively have adjustable DYNAMIC Web pages.

The reduction of a VIRTUAL “Catalogue” Shopping and VIRTUAL “Flyer” Shopping Systems Web page or pages may leave significant “blank” spaces around the VIRTUAL “Catalogue” and VIRTUAL “Flyer” on each page. Same could be left “blank” by an e-tailer and/or used to present “Non-Weighty” graphics and/or additional text and/or advertisements and/or one or more of the following: images; digitized photos; icons; symbols; description information; pricing information; textual information; graphics; or other data. The content in the blank space can be static, dynamic, or a combination of static and dynamic features as discussed above.

In addition to the above, the VIRTUAL “Catalogue” Shopping and VIRTUAL “flyer” Shopping Systems may also have an “additional” feature whereby the consumer can select a download option in order to receive the appropriate “size” of the VIRTUAL “Catalogue” Shopping and VIRTUAL “Flyer” Shopping Web pages (by selecting Options A, B, C, or others from a “Tool Bar”) to download, maximizing his/her own download speed (minimizing download time for each Web page) and/or optimizing the size of Web pages which he/she wishes to download and view—depending on the speed of his/her Internet connection. Instructions would be provided to assist a consumer on which Option to select—for example, if the consumer has a slow modem of approximately 56 KB per second, Option A would provide a download time per page of 8 to 10 seconds (page size=½ computer monitor screen) and Option B a download time per page of 15 to 20 seconds (page size=“FULL” computer monitor screen).

VIII. Appendices

Additional information about exemplary implementations of an on-line virtual Catalogue are provided in the Appendices, which are incorporated herein and form a part of this specification. The following identifies the Appendices.

Appendix A: Booklet of color screens for display of an exemplary VIRTUAL Catalogue and/or VIRTUAL Flyer as web pages on a computer, for example, and illustrating various inventions of the VIRTUAL Catalogue and/or VIRTUAL Flyer discussed in the present application.

Appendix B: Additional exemplary color screens illustrating the QUICK Buy feature of the VIRTUAL Catalogue and/or VIRTUAL Flyer discussed in the present application.

Appendix C: Exemplary color screens for display of an exemplary VIRTUAL Catalogue and/or VIRTUAL Flyer on a personal digital assistant (PDA) or other portable device.

Appendix D: Exemplary templates and grids illustrating the feature of permitting retailers to configure their own pages for a VIRTUAL Catalogue and/or VIRTUAL Flyer.

Appendix E: Examples of different size Web pages for illustrating adjustable “weight” of web pages for a VIRTUAL Catalogue and/or VIRTUAL Flyer. The Web pages include a 100% page (not reduced), which is the approximate or exemplary size displayed on a regular 15′ computer monitor screen, and the same page shown as reduced 90%, 80%, 60%, and 50%. The particular amounts of reduction are shown for illustrative purposes only, and any amount of reduction can be used for the adjustable “weight.” Also, the relative sizes of the pages can be adjusted for display on other size monitors, televisions, or other display devices.

The content shown in the screens of the appendices is provided for illustrative purposes only and other types of the content can be used for implementing a VIRTUAL Catalogue and/or VIRTUAL Flyer as described in the present application including the exemplary claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for providing a virtual on-line catalogue or flyer, comprising:
displaying information relating to a product or service;
providing a symbol within the displayed information for selection by a user; and
recording an identification of the product or service for purchase upon detecting the user's selection of the symbol.

2. The method of claim 1 wherein:
the displaying step includes displaying an image of the product; and
the providing step includes displaying an icon overlaid on the image.

3. The method of 1 wherein:
the displaying step includes displaying textual information relating to the product or service; and
the providing step includes displaying an icon overlaid on the textual information.

4. The method of claim 1 wherein the recording step includes recording the identification in an electronic shopping basket.

5. The method of claim 1, further including transferring a network connection of the user to another web site upon detecting the selection of the symbol.

6. The method of claim 1, further including transferring a network connection of the user to a web site providing electronic order processing for on-line purchases of products or services based upon the selection of the symbol.

7. The method of claim 5 wherein the transferring step includes transferring the network connection to a web site corresponding with an entity providing the products or services.

8. The method of claim 5 wherein the transferring step includes transmitting an identification of the user along with the transfer of the network connection.

9. The method of claim 1, further including displaying instructions relating to selection of the symbol for purchase of the product or service.

10. The method of claim 1 wherein the providing step includes displaying at least one of the following: an icon; one or more words; one or more letters; alphanumeric information; or a graphic.

11. The method of claim 1, further including permitting selection of the symbol by one or more of the following: a touch screen; a cursor control device; or keyed input.

12. The method of claim 1 wherein the displaying step includes selectively displaying textual information in multiple languages.

13. The method of claim 1 wherein:
the displaying step includes displaying information relating to a plurality of products or services; and
the providing step includes providing a plurality of symbols within the displayed information for selection by a user; and
further including associating the plurality of symbols with a plurality of individual web sites.

14. The method of claim 13, further including transferring, upon detecting the user's selection of one of the symbols, a network connection of the user to one of the plurality of web sites associated with the selected symbol.

15. The method of claim 1 wherein the providing step includes displaying an icon for selection by the user to add an identification of the corresponding product to an electronic shopping basket without any additional user input.

16. The method of claim 1, further including displaying, upon detecting the user's selection of the symbol, a warning window permitting the user to confirm the selection of the product or service for purchase or to cancel the selection.

17. The method of claim 1, further including providing a confirmation of the selection of the symbol.

18. The method of claim 17 wherein the providing step includes providing one or more of the following as the confirmation: a text message; an audible sound; highlighting the symbol; flashing the symbol; altering a visual appearance of the symbol; or in any other way.

19. The method of claim 1 wherein the providing step includes associating the symbol with a plurality of products or services.

20. A method for providing a virtual on-line catalogue or flyer, comprising:
specifying a plurality of electronic pages for displaying information relating to products or services in a plurality of categories;
displaying a symbol relating to an index identifying the plurality of categories;
displaying at least a portion of the index upon detecting a user's selection of the symbol; and
electronically linking the identification of the categories in the index with the pages for the corresponding products or services.

21. The method of claim 20, further including:
detecting a user's selection of one of the identified categories in the index; and
displaying one of the pages corresponding with the selected category.

22. The method of claim 21 wherein the displaying the one or more pages step includes displaying a first page within an organized set of pages for the selected category.

23. The method of claim 20, further including:
displaying a symbol relating to an index page; and
displaying the index within a margin of each displayed page upon detecting a user's selection of the symbol relating to the index page.

24. The method of claim 20, further including specifying one or more of the following as the categories within the index: types of product; gender-specific products; products as gifts; products for particular occasions; products within a particular price range; or many other “categories”.

25. The method of claim 20 wherein the displaying the index step includes displaying the identifications of the categories in one or more of the following orders: alphabetical order; reverse alphabetical order; non-alphabetical order; an order based upon particular criteria; or a random order.

26. The method of claim 20 wherein the displaying the symbol step includes displaying the symbol at a particular location within each displayed page.

27. The method of claim 20, further including:
receiving an identification of a particular product type;
searching for information relating to the particular product type; and
displaying an identification of pages resulting from the search.

28. The method of claim 20 wherein the displaying the index step includes displaying a separate page or pages containing the index, the separate page or pages being displayed at the beginning, end, or in between a plurality of pages for a particular web site.

29. A method for providing a virtual on-line catalogue or flyer, comprising:
specifying a plurality of electronic pages for displaying information relating to products or services in a plurality of categories;
organizing the plurality of pages in a particular order;
displaying a current one of the plurality of pages; and
selectively displaying at least a portion of the particular order along with an identification of the current displayed page within the order.

30. The method of claim 29 wherein the selectively displaying step includes:
displaying a list identifying at least a portion of the pages in numerical order; and
identifying in the list a category for each identified page.

31. The method of claim 29, further including:
permitting the user to select an identification of a particular page within the displayed order of pages; and
displaying the particular page upon detecting the user's selection of the identification of the particular page.

32. The method of claim 29, further including electronically linking identifications of the pages in the displayed order within the corresponding pages.

33. The method of claim 29 wherein the selectively displaying step includes displaying the portion of the particular order in a pull-down menu; a pop-up window; or in any other visual way.

34. A method for providing a virtual on-line catalogue or flyer, comprising:
specifying a plurality of electronic pages for displaying information relating to products or services in a plurality of categories;
organizing the plurality of pages in a particular order;
recording, based upon user input, an identification of a set of the pages; and
displaying only pages within the set of pages upon selection by the user.

35. The method of claim 34, further including permitting the user to add an identification of one of the pages to the set.

36. The method of claim 34, further including permitting the user to delete an identification of one of the pages from the set.

37. The method of claim 34, further including permitting the user to specify a particular order in which to display the pages within the set.

38. The method of claim 34 wherein the displaying step includes invoking the display of only the pages in the set upon detection of the user's selection of a favorites symbol.

39. The method of claim 34 wherein the displaying step includes:
organizing the pages of the set in a particular order; and
displaying the pages in the order upon detecting the user's repeated selection of a next page symbol.

40. The method of claim 39, further including providing an indication of a last displayed page in the order.

41. The method of claim 34, further including saving the identification of the set of pages associated with an identification of the user.

42. The method of claim 34, further including deleting the identification of the set of pages based upon a time parameter.

43. The method of claim 34, further including saving the identification of the set of pages based upon session-related information.

44. The method of claim 34, further including associating the set of pages with a wish list for specifying products desired by the user.

45. A method for providing a virtual on-line catalogue or flyer, comprising:
displaying, within a page, an image relating to a plurality of products or services;
detecting a selection of the image by a user; and
displaying on a separate page a larger image of the plurality products based upon the selection by the user.

46. The method of claim 45 wherein the displaying the separate page step including displaying additional information relating to the plurality of products or services.

47. The method of claim 45, further including displaying instructions for purchasing one of the products or services.

48. The method of claim 45, further including transferring a network connection of the user to another web site for display of the separate page.

49. The method of claim 48 wherein the transferring step includes transferring the network connection to a web site corresponding with an entity providing the products or services.

50. The method of claim 48 wherein the transferring step includes transmitting an identification of the user along with the transfer of the network connection.

51. A method for providing a virtual on-line catalogue or flyer, comprising:
displaying, within a page, an image relating to a plurality of products or services;
detecting a selection of a section of the image by a user; and
displaying on a separate page a larger image of the section of the image based upon the selection by the user.

52. The method of claim 51 wherein the displaying the separate page step includes displaying additional information relating to products or services identified within the section of the image.

53. The method of claim 51, further including displaying instructions for purchasing one of the products or services.

54. The method of claim 51, further including transferring a network connection of the user to another web site for display of the separate page.

55. The method of claim 54 wherein the transferring step includes transferring the network connection to a web site corresponding with an entity providing the products or services.

56. The method of claim 54 wherein the transferring step includes transmitting an identification of the user along with the transfer of the network connection.

57. A method for providing a virtual on-line catalogue or flyer, comprising:
specifying a plurality of electronic pages for displaying information relating to products or services in a plurality of categories;
organizing the plurality of pages in a particular order having a first page and a last page;
displaying the pages according to the order based upon a user's selection of a next page; and
displaying a particular one of the pages upon detecting the user's selection of the next page while viewing the last page.

58. The method of claim 57 wherein the displaying the particular page step includes displaying the first page upon detecting the user's selection of the next page while viewing the last page.

59. The method of claim 57 wherein the displaying the particular page step includes transferring a network connection of the user to a particular page of another web site upon detecting the user's selection of the next page while viewing the last page.

60. The method of claim 57, further including:
displaying a home button; and
displaying a particular preprogrammed page upon detecting the user's selection of the home button.

61. The method of claim 60 wherein the displaying the particular preprogrammed page step includes displaying the home page of an entity providing the products or services.

62. A method for providing a virtual on-line catalogue or flyer, comprising:
specifying a plurality of templates for electronic pages, the templates having varying configurations and layouts of sections for containing content;
receiving a selection of one of the plurality of templates;
receiving content for the selected template;
entering the content into the sections based upon user input; and
formatting the selected template with the received content into an electronic page for displaying information relating to products or services identified by the received content.

63. The method of claim 62 wherein the specifying step includes specifying at least one of the templates having overlapping sections.

64. The method of claim 62 wherein the receiving content step includes receiving at least one of the following: images; digitized photographs; icons; symbols; description information; pricing information; textual information; graphics; or other data.

65. The method of claim 62 wherein the entering step includes generating a displayed border around at least one of the sections.

66. The method of claim 62, further including deleting one or more of the sections from the selected template based upon user input.

67. The method of claim 62, further including adding one or more new sections to the selected template based upon user input.

68. The method of claim 62 wherein the formatting step includes formatting the selected template into a web page for network transmission.

69. A method for providing a virtual on-line catalogue or flyer, comprising:
specifying a template for electronic pages, the templates having a plurality of connected sections forming a grid;
receiving multiple selections of the sections;
joining the selected sections to form a plurality content sections based upon the multiple selections;
receiving content for the content sections;
entering the content into the content sections based upon user input; and
formatting the selected template with the received content into an electronic page for displaying information relating to products or services identified by the received content.

70. The method of claim 69 wherein the joining step includes forming polygonal shapes or curvilinear shapes for the content sections.

71. The method of claim 69 wherein the receiving content step includes receiving at least one of the following: images; digitized photographs; icons; symbols; description information; pricing information; textual information; graphics; or other data.

72. The method of claim 69 wherein the formatting step includes formatting the selected template into a web page for network transmission.

73. A method for providing a virtual on-line catalogue or flyer, comprising:
specifying a template for electronic pages, the templates having a plurality of dots forming a grid;
receiving multiple selections of the dots;
joining the selected sections to form a plurality content sections based upon the multiple selections;
receiving content for the content sections;
entering the content into the content sections based upon user input; and
formatting the selected template with the received content into an electronic page for displaying information relating to products or services identified by the received content.

74. The method of claim 73 wherein the joining step includes forming polygonal shapes or curvilinear shapes for the content sections.

75. The method of claim 73 wherein the receiving content step includes receiving at least one of the following: images; digitized photographs; icons; symbols; description information; pricing information; textual information; graphics; or other data.

76. The method of claim 73 wherein the formatting step includes formatting the selected template into a web page for network transmission.

77. A method for providing a virtual on-line catalogue or flyer, comprising:
displaying within a page information relating to a product or service;
providing a way for a user to select the product or service for purchase;
assembling the page for display from information in one or more stored locations; and
configuring the page in a static format wherein the page maintains a same presentation.

78. The method of claim 77 wherein the configuring step includes configuring the page in one of a plurality of weights relating to varying sizes of the corresponding page for electronic transmission and display.

79. The method of claim 78 wherein the configuring step includes selecting a particular one of the weights for the page based upon a download speed requirement of a particular user or market.

80. The method of claim 77, further including:
allowing a user to select a download option; and
transmitting the page in a particular weight based upon the selected download option.

81. The method of claim 77 wherein the configuring step includes providing templates or grids for use in configuring the page in a plurality of weights.

82. The method of claim 78 wherein the configuring step includes selecting a percentage adjustment for the weights based upon a viewable area of a display device for presentation of the page.

83. The method of claim 77 wherein the assembling step includes assembling the page to contain static features, dynamic features, or a combination of static and dynamic features.

84. The method of claim 77, further including transmitting the page as a single unit or as multiple components.

85. A method for providing a virtual on-line catalogue or flyer having an adjustable weight page, comprising:
displaying within a page information relating to a product or service;
providing a way for a user to select the product or service for purchase; and
configuring the page in a plurality of weights relating to varying sizes of the corresponding page for electronic transmission and display.

86. The method of claim 85 wherein the configuring step includes selecting a particular one of the weights for the page based upon a connection speed requirement of a particular user or market.

87. The method of claim 85, further including:
allowing a user to select a download option; and
transmitting the page in a particular one of the weights based upon the selected download option.

88. The method of claim 85 wherein the configuring step includes providing templates or grids for use in configuring the page in the plurality of weights.

89. The method of claim 85 wherein the configuring step includes selecting a percentage adjustment for the weights based upon a viewable area of a display device for presentation of the page.

90. The method of claim 85, further including assembling the page to contain static features, dynamic features, or a combination of static and dynamic features.

91. The method of claim 85, further including transmitting the page as a single unit or as multiple components.

92. The method of claim 85 wherein the configuring step includes performing the configuring automatically based upon programmatic control or performing the configuring manually based upon user input.

93. An apparatus for executing the method recited in claim 1.

94. A computer program product, comprising:
a computer-readable medium containing instructions for controlling a computer system to perform the method recited in claim 1.
